(19) United States
(12) Patent Application Publication
(10) Pub. No.: US 2026/0346758 A1
(43) Pub. Date: Nov. 5, 2026

(54) MINIMIZING THE MOTOR TORQUE OF A WOUND-ROTOR SYNCHRONOUS MACHINE DURING THE THERMAL PRECONDITIONING OF THE BATTERY

(71) Applicant: AMPERE S.A.S., Boulogne Billancourt (FR)

(72) Inventors: Abdelkader BOUARFA, Guyancourt (FR); Noelle JANIAUD, Guyancourt (FR); Tomy ROBIN, Guyancourt (FR)

(73) Assignee: AMPERE S.A.S., Boulogne Billancourt (FR)

(21) Appl. No.: 19/103,310

(22) PCT Filed: Jul. 6, 2023
(86) PCT No.: PCT/EP2023/068776

§ 371 Date: Mar. 6, 2025

(30) Foreign Application Priority Data
Aug. 12, 2022 (FR) FR2208285

(51) Int. Cl. B60L 58/27; B60L 15/02

(52) U.S. Cl. CPC B60L 58/27; B60L 15/025; B60L 2220/14; B60L 2240/423; B60L 2240/425; B60L 2240/545; B60L 2260/22

(57) ABSTRACT

A method generates thermal losses in a powertrain that includes a synchronous electric machine with a stator and a wound rotor. The method includes acquiring a temperature in or around the powertrain, estimating a relative angle between the rotor and the stator, and controlling, depending on the acquired temperature, the rotor and the stator so that they generate thermal losses and that they remain substantially stationary relative to one another, the rotor being controlled with a nonzero rotor current.

The present invention relates generally to electric machines, notably electric machines supplied by a battery.

It relates more particularly to the conditioning, or preheating, of the battery associated with an electric machine.

The invention finds a particularly advantageous application in the field of motor vehicles.

### PRIOR ART

Certain electric machines supplied by a battery, notably electric machines in motor vehicles, are sometimes subjected to very low, or even negative, temperatures, for example during winter.

However, the performance of the battery is, to a certain extent, inversely proportional to the temperature. Thus, during the start-up of the electric machine, for example on ignition of a motor vehicle after being parked for a prolonged period outside in cold weather, the battery performance may leave something to be desired.

Solutions exist for preheating the battery prior to the use of the motor vehicle, which aim to obtain optimal performance of the vehicle right from the first few moments of its use.

Among these solutions, there is the addition of a device for additional heating, called PTC (Positive Temperature Coefficient) heating, dedicated to preheating the battery. However, this solution is expensive.

Another solution comprises controlling the electric machine in such a way as to increase the thermal losses produced by the powertrain, and to use this surplus of heat to heat the battery.

In order to preheat the battery while the vehicle is parked, it is necessary that the control of the electric machine does not lead to the formation of a motor torque in order to keep the vehicle immobile. This solution involves having precise knowledge of the position of the rotor such that the electromagnetic force generated by the stator does not give rise to torque. However, the rotor position measured by the vehicle may be incorrect by a few degrees. This then results in the generation of a motor torque which can lead to the vehicle being set in motion.

The French patent application published under the number FR 3 080 239 proposes such a method in which the control of the stator is servo-controlled in relation to the value of the measurement error for the rotor position.

### PRESENTATION OF THE INVENTION

In order to provide an alternative to the prior art, the present invention proposes increasing the thermal losses of the powertrain without producing a torque which would set the vehicle in motion, nor servo-controlling the control of the stator in relation to the value of the measurement error for the rotor position.

More particularly, what is proposed according to the invention is a method for generating thermal losses in a powertrain which comprises a synchronous electric machine having a stator and a wound rotor, the method comprising:
a step of acquiring a temperature in or around the powertrain,
a step of estimating a relative angle between the rotor and the stator,
as a function of the acquired temperature, a step of controlling the rotor and the stator such that they generate thermal losses and such that they remain substantially immobile with respect to one another,
   wherein the stator is controlled, in a Park reference frame resulting from the estimation of the relative angle, such that a first of the stator currents is zero and such that a second of the stator currents is non-zero, and
   in that the rotor is controlled with a non-zero rotor current.

The estimation of the relative angle between the rotor and the stator may comprise an estimation of the relative angle between the rotor and the stator currents. In other words, the (estimated or measured) angle of the rotor is used and a Park transformation is applied to the three currents for controlling the stator in order to obtain the two stator currents in the Park reference frame. The relative angle between the stator currents in the Park reference frame and the rotor is then directly contained in the first and second stator currents, since the control of the stator can be expressed, in the Park reference frame, in polar coordinates with the aid of the amplitude of the stator current vector and the angle of the stator current vector with respect to the q-axis of the Park reference frame.

By virtue of the invention, it is possible to generate thermal losses while maintaining a negligible or zero torque. In particular, the control of the rotor makes it possible in a simple manner to compensate for a torque which would be due to a measurement error for the rotor position. Determination of a possible error in relation to the measured position of the rotor, and servo-control of the control of the stator in relation to the measurement error for the rotor position, are therefore dispensed with.

Other advantageous and nonlimiting features of the electric machine according to the invention, considered individually or in any technically possible combination(s), are as follows:
the second stator current and the rotor current are determined as a function of the acquired temperature.
the second stator current and the rotor current are such that the rotor remains immobile even if the estimated relative angle has an error of more or less than 15 degrees, and preferably of more or less than 45°.
since the electric machine is supplied by a traction battery, the temperature is measured at the traction battery.
at least some of the thermal losses are transmitted to the traction battery by a heat transfer circuit.
the control of the rotor and the control of the stator comprise the use of a look-up table which makes it possible to associate each temperature value with a value of the second of the stator currents and with a value of the rotor current.
if the acquired temperature is lower than a predetermined first threshold, then the second of the stator currents and the rotor current are equal to predetermined first values, if the acquired temperature is between the first threshold and a second threshold, then the second of the stator currents and the rotor current are equal to predetermined second values, for example a second value of the second stator current and a second value of the rotor current that are greater in terms of absolute value than the predetermined first value of the second rotor current and the predetermined second value of the rotor current, respectively, if the acquired temperature is greater than the second threshold, then the second of the stator currents and the rotor current are equal to third values, for example a predetermined third value of the second stator current and a predetermined third value of the rotor current that are greater in terms of absolute value than the predetermined second value of the second stator current and the predetermined second value of the rotor current, respectively.
the rotor is controlled with a rotor current capable of generating a torque lower than or equal to 2 N·m.

According to another aspect of the invention, what is proposed is a powertrain comprising a synchronous electric machine which has a rotor and a wound stator and is equipped with a module for controlling the rotor and the stator that is configured to implement the method according to the invention.

Other advantageous and nonlimiting features of the powertrain according to the invention, considered individually or in any technically possible combination(s), are as follows:
the powertrain comprises a traction battery and a heat transfer circuit common to the electric machine and to the traction battery, the heat transfer circuit being adapted to cool the electric machine and the traction battery.
the heat transfer circuit has a first section associated with the traction battery and a second section associated with the stator, the first section and the second section being thermally coupled in a first configuration of the heat transfer circuit and thermally isolated in a second configuration of the heat transfer circuit
the heat transfer circuit has at least one valve configured to, in the first configuration of the heat transfer circuit, thermally couple the first section and the second section and, in the second configuration, thermally isolate the first section from the second section.

According to another aspect of the invention, what is proposed is a motor vehicle equipped with a powertrain according to the invention.

Of course, the various features, variants and embodiments of the invention may be combined with one another in various combinations provided that they are not incompatible with one another or mutually exclusive.

### DETAILED DESCRIPTION OF THE INVENTION

The description below, with reference to the attached drawings given by way of nonlimiting examples, will make it easy to understand what the invention consists of and how it may be carried out.

In the attached drawings:

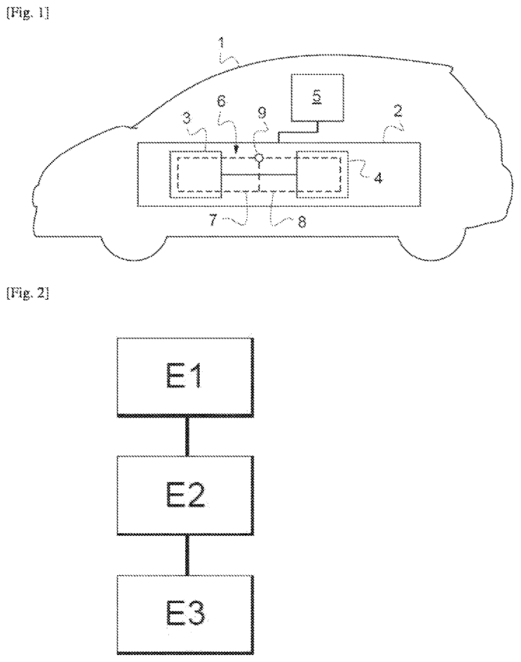

FIG. 1 illustrates a motor vehicle equipped with a powertrain according to the invention and adapted for the implementation of the method according to the invention;

FIG. 2 illustrates one mode of implementation of the method according to the invention;

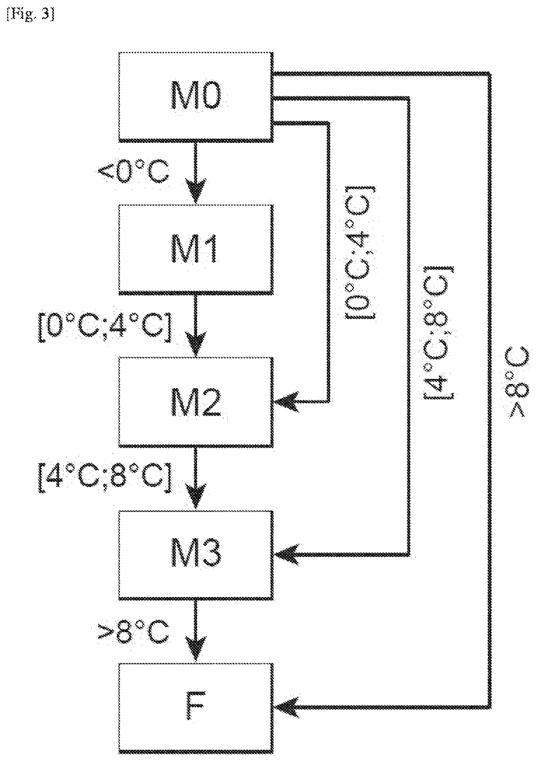

FIG. 3 illustrates another mode of implementation of the method according to the invention;

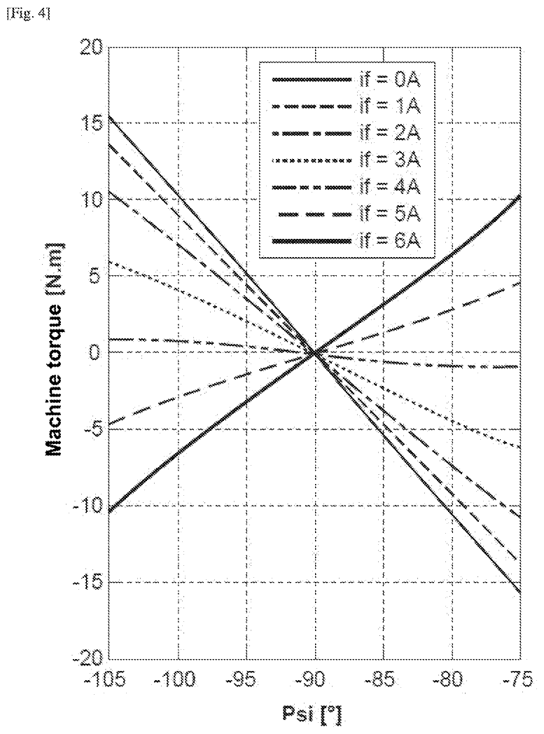

FIG. 4 illustrates the change in the torque applied to the rotor of an electric machine as a function of the uncertainty regarding the rotor position, for various rotor-current values;

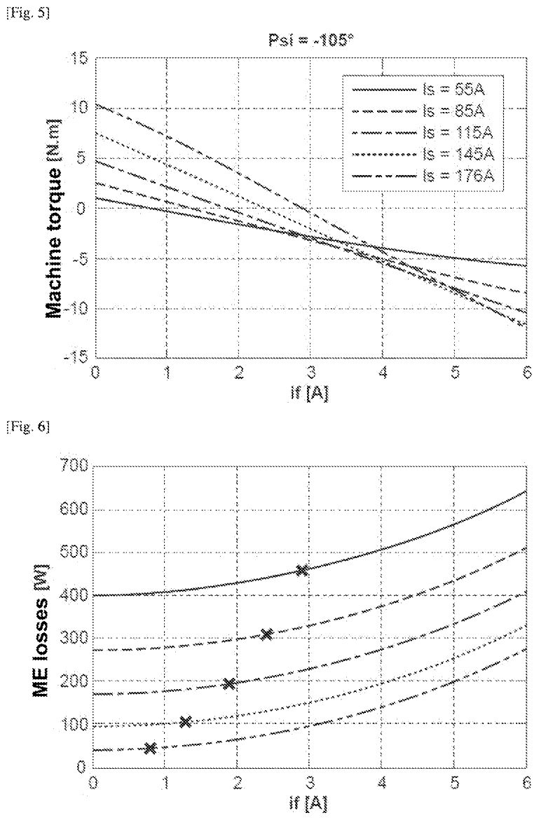

FIG. 5 illustrates the change in the motor torque as a function of the rotor current, for various stator-current values;

FIG. 6 illustrates the change in the losses generated by the electric machine of the vehicle as a function of the rotor current, for various stator-current values;

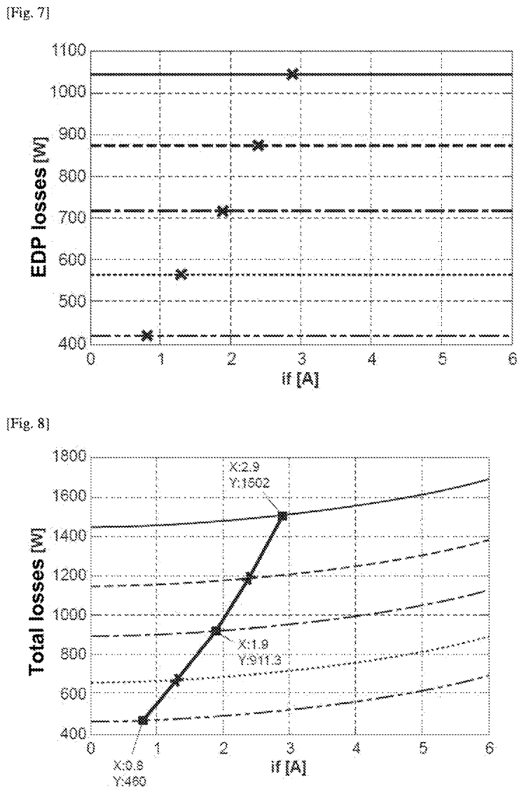

FIG. 7 illustrates the change in the losses generated by the power electronics of the powertrain of the vehicle as a function of the rotor current, for various stator-current values;

FIG. 8 illustrates the change in the total losses generated by the powertrain of the vehicle as a function of the rotor current, for various stator-current values.

As a preliminary, it will be noted that identical elements of the invention that are shown in the various figures will, as far as possible, be referenced by the same reference signs.

It will also be noted that, in this description, an example of a motor vehicle according to the invention will be described first, then an example of a method implemented by this vehicle, before describing how this method has been parameterized.

FIG. 1 illustrates a motor vehicle 1 equipped with a powertrain 2 comprising an electric machine 3, in this case a synchronous three-phase wound-rotor electric machine, supplied by a traction battery 4 providing a continuous electric current. The powertrain 2 further comprises various components (not shown), notably power electronics components, for example making it possible for the current provided by the traction battery 4 to be adapted to the control of the electric machine. An inverter is an example of such a component.

A control module 5 is in this case configured to control the electric machine 3, notably to control the control signals circulating in the rotor and in the stator of the motor vehicle 1.

The motor vehicle 1 is in this case equipped with a heat transfer system 6 thermally coupled to the electric machine 3 and to the traction battery 4.

In this case, the heat transfer circuit 6 has a first section 7 coupled to the electric machine 3, and a second section 8 coupled to the traction battery 4. Each of these sections has one or more lines for circulating cooling liquid, and a heat exchanger associated with the electric machine 3 or with the traction battery 4.

In this embodiment, the heat transfer circuit 6 has a system 9 of valves making it possible to connect the first section 7 and the second section 8 such that they form a single circuit, or to isolate the first section 7 from the second section 8 such that they form two separate, that is to say thermally isolated, circuits. For example, the system of valves is controlled by the control module 5. For example, the control means may control the system of valves such that the sections 7, 8 are separated during running of the vehicle 1, and such that they are coupled during the implementation of the method according to the invention.

The motor vehicle 1 is adapted for the implementation of the method according to the invention. The control module 5 is in this case programmed to control the electric machine 3 in such a way that it generates thermal losses that are independent of the motor torque, for example when the vehicle is at a standstill, as detailed below.

FIG. 2 illustrates one mode of implementation of the method by the control module of the motor vehicle 1.

For the purposes of simplifying the explanation, the control of the stator is in this case considered in a Park reference frame of axes d, q. The Park transform makes it possible to model the three-phase system of the electric machine 3, conventionally presented in a fixed reference frame linked to the stator, by way of a two-phase system in a rotating frame of reference linked to the rotor. Thus, the control of the stator will not be presented in this case as a triplet of alternating currents phase-shifted by 120°, but as a pair of direct currents Id and Iq (hereinafter first stator current Iq and second stator current Id). The first stator current Id corresponds to the stator current projected onto the direct axis of the rotor (conventionally called “d-axis”), which is parallel to the coil of the rotor. The second stator current Iq corresponds to the stator current projected onto the quadrature axis of the rotor (conventionally called “q-axis”), which is perpendicular to the coil of the rotor. The control of the stator can also be expressed, in the Park reference frame, in polar coordinates with the aid of the amplitude Is of the stator current vector and the angle of the current vector with respect to the q-axis of the Park reference frame.

The control module 5 is in this case configured to control the electric machine 3 such that the powertrain generates thermal losses that are independent of the torque applied to the rotor. In particular in this case, the control module is configured to generate thermal losses without leading to a movement of the vehicle 1, that is to say while keeping the torque applied to the rotor lower than a predetermined threshold, for example lower than 5 N·m, or even lower than 2 N·m, and preferably equal to zero.

Preferably, the thermal losses generated by the powertrain are directed to one or more other elements of the powertrain, notably by virtue of the heat transfer circuit 6. Preferably in this case, the thermal losses are directed to the traction battery 4 by way of the heat transfer circuit 6 in order to heat this battery when its temperature is low.

In order to know the temperature of the traction battery 4 and to deduce therefrom the quantity of thermal losses to be generated, the method comprises a step E1 of acquiring a temperature in or around the powertrain, for example at the battery 4, notably by way of one or more dedicated temperature sensors.

The control module 5 then implements a step E2 of estimating the position of the rotor, for example with the aid of a module for measuring the relative angle between the rotor and the stator, thus allowing said control module to generate the suitable control of the stator in the Park reference frame corresponding to the estimated position.

As a function of the acquired temperature, the control module 5 controls the electric machine 3 such that it generates thermal losses and such that the rotor and the stator remain substantially immobile with respect to one another (step E3). The thermal losses may, for example, be generated as a function of the measured temperature of the traction battery 4 and of a target temperature to be reached.

In particular, the control module 5 controls the electric machine 3 such that, in the Park reference frame determined on the basis of the relative position of the rotor and the stator, the first stator current Iq is zero and the second stator current Id has a non-zero value which depends on the acquired temperature, or, in polar coordinates, such that the amplitude Is of the current vector is dependent on the acquired temperature and such that the angle Psi is zero.

In order notably to compensate for any error in the estimation of the rotor position, the control module 5 controls the rotor with a non-zero rotor current.

The method according to the invention may advantageously be used in the context of the preconditioning, or preheating, of the traction battery 4, prior to the use of the vehicle 1, in order for, even in cold weather, the traction battery 4 to have optimal performance right from the first few moments of use of the vehicle.

The method according to this embodiment may be programmed so as to trigger at a precise time in the day, for example an hour before the use of the vehicle 1, or to be directly triggered remotely, for example with the aid of a mobile communication system, notably from a computer connected to the Internet.

In this method, the control module is configured to operate according to three different active modes, depending on the temperature of the battery 4. The idea is that the losses emitted are all the greater the lower the temperature is.

In a first operating mode associated with a temperature of the battery 4 that is lower than a predetermined first threshold, in this case 0 °C, the second stator current is equal to a first stator-current value, in this case −176 A, and the rotor current is equal to a first rotor-current value, in this case 2.9 A.

In a second operating mode associated with a temperature of the battery 4 that is between the first threshold and a second threshold, in this case 4 °C, the second stator current Id is equal to a second stator-current value, in this case −115 A, and the rotor current is equal to a second rotor-current value, in this case 1.9 A.

In a third operating mode associated with a temperature of the battery 4 that is greater than the second threshold and lower than a third threshold, in this case 8 °C, then the second stator current is equal to a third stator-current value, in this case −55 A, and the rotor current is equal to a third rotor-current value, in this case 0.8 A.

When the temperature of the battery reaches the third threshold, then the method comes to an end (inactive mode).

For example, in an initial situation, the vehicle has been parked outside in cold weather and the battery 4, which has been inactive for a sufficiently long period of time, has a temperature substantially equal to the outside temperature, in this case −5 degrees.

As illustrated in FIG. 3, when the method is triggered, the control module 5 triggers a measurement M0 of the temperature of the battery. In this case, the measured temperature is lower than the first threshold and the method is therefore triggered according to the first mode M1, which in this case leads to the generation of a thermal power of 1500 W by the powertrain. The control module 5 maintains the corresponding current values so as to increase the temperature of the battery. If the measured temperature had been different, the method would have proceeded according to a different operating mode, for example an operating mode leading to the generation of a lower thermal power, in this case the second mode M2 or the third mode M3.

When the temperature of the battery 4 reaches the first threshold, the method is implemented according to the second mode M2, which in this case leads to the generation of a thermal power of 900 W by the powertrain, and the temperature of the battery 4 continues to increase. When the temperature reaches the second threshold, the method is implemented according to the third mode M3, which in this case leads to the generation of a thermal power of 450 W, and the temperature of the battery continues to increase. When the temperature reaches the third threshold, the method stops (step F, corresponding to the inactive mode) and the motor vehicle is capable of being used with optimal performance of the battery.

The values of the currents for controlling the electric machine 3 are in this case selected from a pre-established look-up table. For example, the look-up table may have been established on the basis of a computer program implementing a quasi-static energy model, in this case a model of an assembly comprising the inverter and the electric machine.

In order to clearly understand the principle on which this model is based and how these values have been selected, the following equation giving the value of the torque Ce applied to the rotor should be considered:

$$Ce = \frac{3 p}{2} ( Ld \cdot Id \cdot Iq - Lq \cdot Id \cdot Iq + Mf \cdot If \cdot Iq ) \qquad [ Math . 1 ]$$

where Ld and Lq are the stator inductances on the d- and q-axes of the Park reference frame (these inductances not being equal in a machine with salient poles), Mf is the mutual inductance between the rotor and the stator, If is the rotor current and p is the number of pairs of poles of the stator.

In order to cancel the value of the torque Ce, the cancelation of the first value of the stator current Iq appears obvious. The production of thermal losses would then be ensured by the second stator current Id.

However, the notion of first stator current Iq and of second stator current Id is only meaningful relative to the position of the rotor, since the Park reference frame is a reference frame linked to the rotor. Thus, in the event of error in the measurement of the position of the rotor, for example an error of a few degrees, the determined values of the stator currents Id and Iq correspond to an incorrect Park reference frame which is slightly offset with respect to its actual position (the position of the rotor). This results in slightly different effective values (in the non-offset Park reference frame) of the currents Id and Iq, and therefore a non-zero current Iq (or a non-zero angle Psi). This then risks producing a dangerous motor torque when the motor vehicle must remain immobile.

The inventors have been able to determine, with the aid of simulations and tests on test rigs, the change in the electromagnetic torque produced by the electric machine as a function of the error regarding the rotor position, reflected in this case by a variation in the angle Psi of more or less than 15° around −90° (i.e. in a range ranging from −105° to −75°), for a fixed value of the second stator current Id equal to −250 A. FIG. 4 illustrates the results from the simulation, for values of stator currents If ranging from 0 to 6 A.

In FIG. 4, it is observed that an optimal value of the rotor current is equal to 4 A, since it makes it possible to ensure a virtually zero torque on the rotor (the “machine torque”) over the entire range of variation studied.

The quasi-static energy model has therefore been developed in order to produce a look-up table, or map of values, which can be used in the method according to the invention. This model takes account of the electromagnetic equations for operating the electric machine and uses parameters of the electric machine that result from simulations. Such a model receives, as input value, the polar coordinates of the stator current in the non-offset Park reference frame, the rotor current, the speed of the electric machine and the temperatures of the rotor and of the stator. The quasi-static energy model provides as output the corresponding torque applied to the rotor shaft and the total losses, that is to say in this case the losses generated by the inverter and the losses generated by the electric machine 3.

FIGS. 5 to 8 illustrate some of the results obtained for an error of 15° in the position of the rotor (i.e. Psi=−105°) as a function of the rotor current. FIG. 5 illustrates the change in the torque applied to the rotor (the “machine torque”), FIG. 6 illustrates the change in the thermal losses generated by the electric machine 3 (the “ME losses”), FIG. 7 illustrates the change in the thermal losses generated by the power electronics of the powertrain 2 (the “EDP losses”) and FIG. 8 illustrates the change in the total losses of the powertrain 2, that is to say the thermal losses generated by the power electronics and by the electric machine 3. Each of the figures shows five curves which correspond to five separate values of the amplitude Is of the current vector in the Park reference frame, in this case 55 A, 85 A, 115 A, 145 A and 176 A. The crosses correspond to zero torque values, and therefore to optimal values of the rotor and stator currents.

It is observed here that the value of the rotor current is greatly dependent on the value of the stator current.

Thus the quasi-static energy model makes it possible to obtain a matching between the stator current, the rotor current and the losses generated by the powertrain such that the motor torque is substantially zero. These values can be recorded in the look-up table used in the method according to the invention.

It is also possible to associate each triplet of values with a corresponding temperature range, in order to implement the method according to the embodiment described above in connection with FIGS. 2 and 3.

The invention is not limited to the embodiments and modes of implementation described above. Thus, although a method implementing three operating modes M1, M2 and M3 that are associated with three temperature threshold values has been described above, the method is compatible with any number of operating modes that are each associated with a separate temperature range. The temperature ranges may also be of different amplitudes. By way of example, it would be possible to provide a single operating mode when the temperature is lower than 8 °C. Also by way of example, it would be possible to provide more than four operating modes.

Furthermore, what has been described here are thermal exchanges between the electric machine 3 and the traction battery 4 in order to heat the latter. The invention is of course not limited to this exchange and preferably the thermal exchanges are effected between multiple elements of the powertrain, for example the inverter and the electric machine and the battery.

Lastly, the invention is not limited to preheating of the battery, but is also applicable to the preheating of other elements of the vehicle 1, for example for heating or preheating elements external to the powertrain 2, typically the interior of the vehicle 1.

Furthermore, the temperature can be measured at another stage of the powertrain or at another stage of the vehicle, and/or at different locations of the vehicle.

Lastly, the method may be implemented for heating another element of the powertrain.

1-12. (canceled)

13. A method for generating thermal losses in a powertrain that comprises a synchronous electric machine having a stator and a wound rotor, the method comprising:
acquiring a temperature in or around the powertrain;
estimating a relative angle between the rotor and the stator;
controlling, as a function of the acquired temperature, the rotor and the stator such that they generate thermal losses and such that they remain substantially immobile with respect to one another,
wherein the stator is controlled, in a Park reference frame resulting from the estimating the relative angle, such that a first of the stator currents is zero and such that a second of the stator currents is non-zero, and
wherein the rotor is controlled with a non-zero rotor current.

14. The method as claimed in claim 13, wherein the second stator current and the rotor current are determined as a function of the acquired temperature.

15. The method as claimed in claim 13, wherein the second stator current and the rotor current are configured such that the rotor remains immobile when the estimated relative angle has an error of more or less than 15 degrees.

16. The method as claimed in claim 13, wherein the second stator current and the rotor current are configured such that the rotor remains immobile when the estimated relative angle has an error of more or less than 45 degrees.

17. The method as claimed in claim 13, wherein the electric machine is supplied by a traction battery and the temperature is measured at the traction battery.

18. The method as claimed in claim 17, wherein at least some of the thermal losses are transmitted to the traction battery by a heat transfer circuit.

19. The method as claimed in claim 13, wherein the control of the rotor and the control of the stator comprise the use of a look-up table which makes it possible to associate each temperature value with a value of the second of the stator currents and with a value of the rotor current.

20. The method as claimed in claim 19, wherein
when the acquired temperature is lower than a predetermined first threshold, the second of the stator currents and the rotor current are equal to predetermined first values,
when the acquired temperature is between the first threshold and a second threshold, the second of the stator currents and the rotor current are equal to second values,
when the acquired temperature is greater than the second threshold, the second of the stator currents and the rotor current are equal to third values.

21. The method as claimed in claim 13, wherein the rotor is controlled with a rotor current configured to generate a torque lower than or equal to 2 N·m.

22. A powertrain comprising:
a synchronous electric machine which has a rotor and a wound stator and is equipped with a module configured to control the rotor and the stator to implement the method as claimed in claim 13.

23. The powertrain as claimed in claim 22, further comprising a traction battery and a heat transfer circuit common to the electric machine and to the traction battery, the heat transfer circuit being configured to cool the electric machine and the traction battery.

24. The powertrain as claimed in claim 23, wherein the heat transfer circuit has a first section associated with the traction battery and a second section associated with the stator, the first section and the second section being thermally coupled in a first configuration of the heat transfer circuit and thermally isolated in a second configuration of the heat transfer circuit by a system of valves.

25. A motor vehicle comprising:
the powertrain as claimed in claim 22.
